(19) United States
(12) Patent Application Publication
(10) Pub. No.: US 2016/0147458 A1
(43) Pub. Date: May 26, 2016

(54) COMPUTING SYSTEM WITH HETEROGENEOUS STORAGE AND METHOD OF OPERATION THEREOF

(71) Applicant: Samsung Electronics Co., Ltd., Suwon-si (KR)

(72) Inventors: Anahita Shayesteh, Los Altos, CA (US); Zvi Guz, Palo Alto, CA (US); Jaehwan Lee, Fremont, CA (US)

(21) Appl. No.: 14/677,829

(22) Filed: Apr. 2, 2015

Related U.S. Application Data
(60) Provisional application No. 62/084,448, filed on Nov. 25, 2014.

(51) Int. Cl. G06F 3/06

(52) U.S. Cl. CPC G06F 3/065; G06F 3/0619; G06F 3/0685

(57) ABSTRACT

A computing system includes: a name node block configured to: determine a data node including a high performance device, select a target device, wherein the data node, coupled to the name node block, is configured to: perform a first copy write command to the high performance device, provide a transaction status as completed for the first copy write command, and a replication tracker block, coupled to the data node, configured to perform a background replication to replicate a data content from the first copy write command to the target device after the transaction status is provided as completed.

### CROSS-REFERENCE TO RELATED APPLICATION(S)

This application claims the benefit of U.S. Provisional Patent Application Ser. No. 62/084,448 filed Nov. 25, 2014, and the subject matter thereof is incorporated herein by reference thereto.

### TECHNICAL FIELD

An embodiment of the present invention relates generally to a computing system, and more particularly to a system with heterogeneous storage.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for efficiently storing data.

Research and development in the existing technologies can take a myriad of different directions. Some perform data backup deploying disk-based storage. More specifically, the distributed storage system run on homogenous hardware. Others operate on cloud to store data.

Thus, a need still remains for a computing system with heterogeneous storage mechanisms for efficiently storing data heterogeneously. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested more efficient solutions and, thus, solutions to these problems have long eluded those skilled in the art.

### SUMMARY

An embodiment of the present invention provides a computing system, including: a name node block configured to: determine a data node including a high performance device, select a target device, wherein the data node, coupled to the name node block, is configured to: perform a first copy write command to the high performance device, provide a transaction status as completed for the first copy write command, and a replication tracker block, coupled to the data node, configured to perform a background replication to replicate a data content from the first copy write command to the target device after the transaction status is provided as completed.

An embodiment of the present invention provides a method of operation of a computing system, including: performing a first copy for writing to a high performance device; providing a transaction status as completed for the first copy write command; and performing a background replication with a replication tracker block for replicating a data content from the first copy write command to a target device after the transaction status is provided as completed.

An embodiment of the present invention provides a non-transitory computer readable medium including instructions for execution by a computer block, including: performing a first copy write command for writing to a high performance device; providing a transaction status as completed for the first copy write command; and performing a background replication for replicating a data content from the first copy write command to a target device after the transaction status is provided as completed.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1A is a computing system with a heterogeneous storage mechanism in a first embodiment of the present invention.

FIG. 1B is the computing system with the heterogeneous storage mechanism in a second embodiment of the present invention.

FIG. 2 is the computing system with a heterogeneous storage mechanism in a further embodiment of the present invention.

FIG. 3 is a control flow the computing system.

FIG. 4 is application examples of the computing system as with an embodiment of the present invention.

FIG. 5 is a flow chart of a method of operation of a computing system in an embodiment of the present invention.

### DETAILED DESCRIPTION

Various example embodiments include a computing system performing a background replication to improve the performance of writing a data content to a target device. By marking the writing as complete after a first copy of the data content is written to a first instance of the target device, the computing system can begin replicating the data content in other instance of the target device. As a result, the computing system can improve the performance per hardware cost, the performance per watt, or a combination thereof of the target device.

Various example embodiments include a computing system performing the background replication during, after, or a combination thereof a first copy write command to improve the performance per cost for writing the data content to the target device. By performing the background replication to the storage media type different from the storage media type utilized for the first copy write command, the computing system can efficiently write the data content in a heterogeneous architecture including various instances of the storage media type. As a result, the computing system can improve the efficiency and performance of operating the computing system.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the various embodiments of the invention. However, it will be apparent that various embodiments may be practiced without these specific details. In order to avoid obscuring various embodiments, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “module” referred to herein can include software, hardware, or a combination thereof in an embodiment of the present invention in accordance with the context in which the term is used. For example, a software module can be machine code, firmware, embedded code, and/or application software. Also for example, a hardware module can be circuitry, processor(s), computer(s), integrated circuit(s), integrated circuit cores, pressure sensor(s), inertial sensor(s), microelectromechanical system(s) (MEMS), passive devices, or a combination thereof. Further, if a module is written in the apparatus claims section, the modules are deemed to include hardware circuitry for the purposes and the scope of apparatus claims.

The modules in the following description of the embodiments can be coupled to one other as described or as shown. The coupling can be direct or indirect without or with, respectively, intervening items between coupled items. The coupling can be physical contact or by communication between items.

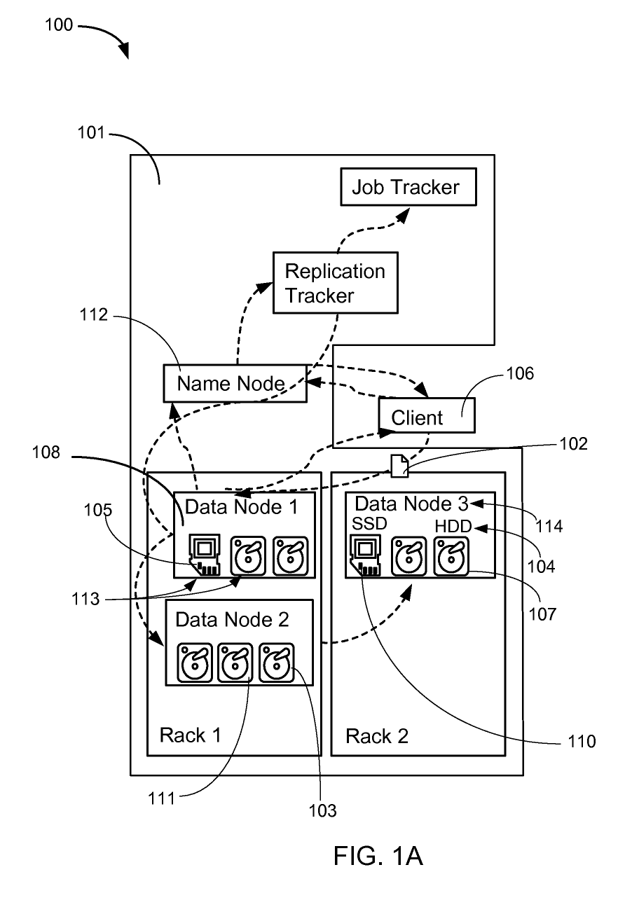

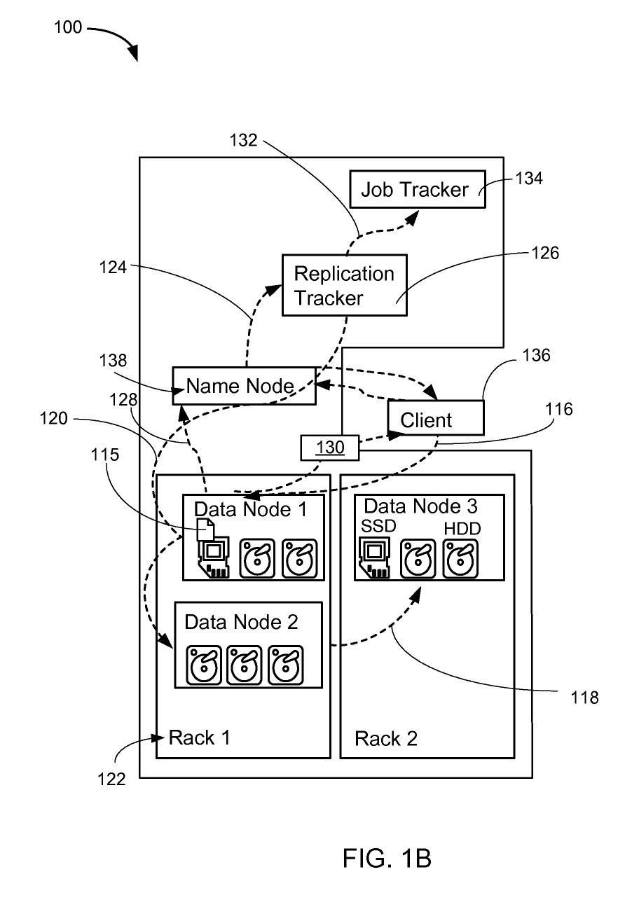

Referring now to FIG. 1A, therein is shown a computing system 100 with a heterogeneous storage mechanism in a first embodiment of the present invention. FIG. 1 depicts one embodiment of the computing system 100 where heterogeneous storage media is used. The term heterogeneous storage can represent writing a data content 102 to a plurality of a storage media type 104. The interactions between components of the computing system 100 can be illustrated in dotted arrow lines.

The computing system 100 can include a computing block 101. The computing block 101 can represent a hardware device or a set of hardware devices to host a heterogeneous storage architecture, a homogeneous storage architecture, or a combination thereof. Details will be discussed below.

The computing system 100 can include a client block 106. The client block 106 interacts with a data node 108. For example, the client block 106 can issue a command to write, read, or a combination thereof the data content 102 to or from the data node 108. The client block 106 can be implemented with hardware, such as logic gates or circuitry (analog or digital). Also for example, the client block 106 can be implemented with a hardware finite state machine, combinatorial logic, or a combination thereof. The client block 106 can be remote from the data node 108.

The computing block 101 can include the data node 108. The data node 108 can be a cluster of a plurality of a storage unit 103 for storing the data content 102. The storage unit 103 can be a volatile memory, a nonvolatile memory, an internal memory, an external memory, or a combination thereof. The data node 108 can represent as an interface to receive a command, the data content 102, or a combination thereof from the client block 106, another block within the computing block 101, an external system (not shown) or a combination thereof. The data node 108 can include a plurality of the storage unit 103 with the storage media type 104.

The storage media type 104 is a category of the storage unit 103. The storage media type 104 can be categorized based on recording media, recording technology, or a combination thereof used to store data. The storage media type 104 can be differentiated by other factors, such as write speed, read speed, latency to storage commands, throughput, or a combination thereof. For example, the storage media type 104 can include a high performance device 110 and a low performance device 111.

The term “high” or “low” are relative terms and can depend on a variety of factors, including but not limited to: caching, firmware, network speed, throughput level, storage capacity, or a combination thereof. The high performance device 110 can represent the storage unit 103 with performance metrics exceeding those of a low performance device 111.

As an example, the high performance device 110 can be implemented with non-volatile integrated circuit memory to store the data content 102 persistently. Also for example, the low performance device 111 can represent the storage unit 103 that uses rotating or linearly moving media to store the data content 102. For further example, the high performance device 110 and the low performance device 111 can be implemented with the same or similar technologies, such as non-volatile memory devices or rotating media, but other factors can differentiate the performance. As an example, a larger cache can differentiate the performance of a storage unit 103 to be considered the high performance device 110 or the low performance device 111.

For example, the high performance device 110 can include a faster caching capability than the low performance device 111. For another example, the high performance device 110 can include a firmware that performs better than the low performance device 111. For a different example, the high performance device 110 can be connected to a network that provides faster communications than the low performance device 111. For another example, the high performance device 110 can have a higher throughput level by processing the data faster than the low performance device 111. For a different example, the high performance device 110 can have a greater storage capacity than the low performance device 111.

For example, the storage media type 104 can include a solid state drive (SSD) 105, a hard disk drive (HDD) 107, or a combination thereof. More specifically as an example, the high performance device 110 can represent the SSD 105. The low performance device 111 can represent the HDD 107. The computing system 100 can provide a heterogeneous distributed file system including the data node 108 including a plurality of the storage unit 103 with a plurality of the storage media types 104. For example, the SSD 105 can represent a high throughput device and the HDD 107 can represent a low throughput device.

For another example, the storage media type 104 can classify the storage unit 103 according to a storage performance. The storage performance can include a throughput level, a storage capacity, or a combination thereof. More specifically as an example, one instance of the storage unit 103 can have the storage performance with a greater throughput than another instance of the storage unit 103. As a result, that one instance of the storage unit 103 can be faster than another instance of the storage unit 103. For further example, the SSD 105 can be faster than the HDD 107.

The computing block 101 can include a name node block 112 for receiving a request from the client block 106 to consult a list of a target device 113 for writing the data content 102. The computing block 101 can include the target device 113. The target device 113 can represent the data node 108, the storage unit 103, or a combination thereof. The target device 113 can represent a plurality of the data node 108 available for writing the data content 102. The target device 113 can represent a plurality of the storage unit 103 within the data node 108 for writing the data content 102.

The client 106 can consult the name node block 112 for a list of the data node(s) 108 available. The list of the data node(s) 108 can include a target count 114, which is a number of the target device(s) 113 available for writing the data content 102. For example, the target count 114 can represent a number of instances of the data node 108 available for writing the data content 102. For a different example, the target count 114 can represent a number of the storage unit 103 available for writing the data content 102.

In a heterogeneous distributed file system, the default number of the target count 114, for example, can represent three instances of the data node 108. However, the target count 114 can range from number greater than zero to n instances of the target device 113. The name node block 112 can be implemented with hardware, such as circuitry or logic gates (analog or digital). Also for example, the name node block 112 can be implemented with a hardware finite state machine, combinatorial logic, or a combination thereof.

Referring now to FIG. 1B, therein is shown the computing system 100 with the heterogeneous storage mechanism in a second embodiment of the present invention. The interactions between components of the computing system 100 can be illustrated in dotted arrow lines.

For example, the name node block 112 of FIG. 1A can provide a list of the data node(s) 108 of FIG. 1A with a variety of the storage media type(s) 104 of FIG. 1A including the high performance device 110 of FIG. 1A, the low performance device 111 of FIG. 1A, or a combination thereof for a first copy write command 116 of the data content 102. The first copy write command 116 can represent a process in a heterogeneous distributed file system where a first copy 115 of the data content 102 of FIG. 1A is written to one instance of the target device 113 of FIG. 1A prior to replicating copies of the data content 102 to other instances of the target device 113.

For a specific example, the first copy write command 116 can represent a process in a heterogeneous distributed file system where the first copy 115 of the data content 102 is written to one instance of the data node 108 prior to replicating copies of the data content 102 to other instances of the data node 108. For a further example, the first copy write command 116 can represent a process in a heterogeneous distributed file system where the first copy 115 of the data content 102 is written to one instance of the storage unit 103 of FIG. 1A prior to replicating copies of the data content 102 to other instances of the storage unit 103. For an additional example, the first copy write command 116 can represent a process in a heterogeneous distributed file system where the first copy 115 of the data content 102 is written to the high performance device 110 prior to replicating copies of the data content 102 to the low performance device 111.

As an example, the data node 108 including the storage media type 104 representing the high performance device 110 can receive the data content 102 as the first copy write command 116 from the client block 106 of FIG. 1A instead of the low performance device 111. As a specific example, the client block 106 can issue a write command 118 to write the data content 102 to the storage unit 103. Stated differently, the data node 108 can receive the write command 118 from the client block 106 for the data content 102 to be written to the storage unit 103.

The name node block 112 can select additional instances of the target device 113 for performing a background replication 120. The background replication 120 can represent a process involving a plurality of the target device 113 where when the first copy write command 116 is completed in one the target device 113, and the write to other instances of the target device 113 is started to replicate the writing of the data content 102.

For example, the background replication 120 can represent a process involving a plurality of the data node 108 where when the first copy write command 116 is completed in one of the data node 108, the write to other instances of the data node 108 is started to replicate the writing of the data content 102. For another example, the background replication 120 can represent a process involving a plurality of the storage unit 103 where when the first copy write command 116 is completed in one of the storage unit 103, the write to other instances of the storage unit 103 is started to replicate the writing of the data content 102. For further example, the background replication 120 can represent a process involving a plurality of the storage unit 103 where when the first copy write command 116 is completed in the high performance device 110, such as the SSD 105 of FIG. 1A, the write to the low performance device 111, such as the HDD 107 of FIG. 1A, is started to replicate the writing of the data content 102.

For a different example, the first instance of the target device 113 can include one instance of the high performance device 110 and multiple instances of the low performance device 111. The other instance of the target device 113 can include a homogenous distributed file system by including multiple instances of low performance device 111. The write to the other instance of the target device 113 can start after the first copy write command 116 to the high performance device 110 in the first instance of the target device 113 is complete even though the write to the low performance device 111 has not been completed.

It has been discovered that the computing system 100 performing the background replication 120 improves the performance of writing the data content 102 to the target device 113. By marking the writing as complete after the first copy 115 of the data content 102 is written to the first instance of the target device 113, the computing system 100 can begin replicating the data content 102 in other instance of the target device 113. As a result, the computing system 100 can improve the performance for a given cost, the performance per watt, or a combination thereof of the target device 113.

The name node block 112 can select the additional instances of the data node 108 based on a device location 122. The device location 122 is information regarding where the target device 113 exists. The computing system 100 can include the computing block 101 of FIG. 1A writing the data content 102 to three instances of the target device 113. For example, the device location 122 can represent the rack information where the target device 113 is set up. For a specific example, the device location 122 where the first instance of the target device 113 can be setup is at rack 1. Continuing with the example, the device location 122 for a second instance of the target device 113 can be set up at rack 1. And the device location 122 for a third instance of the target device 113 can be setup at rack 2.

The name node block 112 can send a transaction information 124 to a replication tracker block 126. The computing block 101 can include the replication tracker block 126. The transaction information 124 can include the target device 113 for performing the background replication 120, the write command 118 to be replicated, the data content 102 to be replicated, or a combination thereof. The replication tracker block 126 tracks whether the background replication 120 is complete, still pending, active, or a combination thereof. The replication tracker block 126 can be implemented with software, hardware, such as logic gates or circuitry (analog or digital), or a combination thereof. Also for example, the replication tracker block 126 can be implemented with a hardware finite state machine, combinatorial logic, or a combination thereof.

The target device 113 can send a transaction message 128 including a transaction status 130. The transaction message 128 is a notification for issuing a command. The transaction status 130 is a result from executing a command. For example, if the computing system 100 was able to execute the write command 118 to write the data content 102 to the target device 113, the transaction status 130 can represent “complete.” In contrast, if the computing system 100 failed to write the data content 102 to the target device 113, the transaction status 130 can represent “error.” For further example, the target device 113 can send the transaction message 128 to the name node block 112, the client block 106, the replication tracker block 126 or a combination thereof to notify the transaction status 130 of “complete” or “error.”

For further example, the transaction status 130 can represent “completed” when the command has been successfully executed. For example, when the write command 118 has been successfully executed for the first copy write command 116, the background replication 120, or a combination thereof, the transaction status 130 can represent “completed.”

The replication tracker block 126 can write the data content 102 to the target device 113 for the background replication 120. The replication tracker block 126 can be responsible for making sure other copies of the data content 102 are written before the first copy 115 of the data content 102 is marked completed. In the event that a copy of the data content 102 is lost before any replication is made, the replication tracker block 126 can send a restart request 132 to a job tracker block 134.

The computing block 101 can include the job tracker block 134. The job tracker block 134 issues or reissues the command, the task, or a combination thereof. The task and command can be synonymous. For example, the job tracker block 134 can reissue the write command 118 requested by the client block 106 to write the data content 102 to the target device 113 if the transaction status 130 represents “error.” More specifically as an example, the job tracker block 134 can reissue the write command 118 based on the restart request 132, which is a call to reissue the command.

The job tracker block 134 can be implemented with software, hardware, such as logic gates or circuitry (analog or digital), or a combination thereof. Also for example, the job tracker block 134 can be implemented with a hardware finite state machine, combinatorial logic, or a combination thereof.

An executor type 136 is information regarding the provider of a command. For example, the executor type 136 can represent that the client block 106 issuing the write command 118 for the write to the high performance device 110. For a different example, the executor type 136 can represent that the replication tracker block 126 issuing the write command 118 during background replication 120. A recipient type 138 can represent a receiver of the transaction message 128. For example, if the transaction message 128 provides the transaction status 130 of “complete,” the recipient type 138 of the transaction message 128 can represent the name node block 112, the client block 106, or a combination thereof instead of the job tracker block 134.

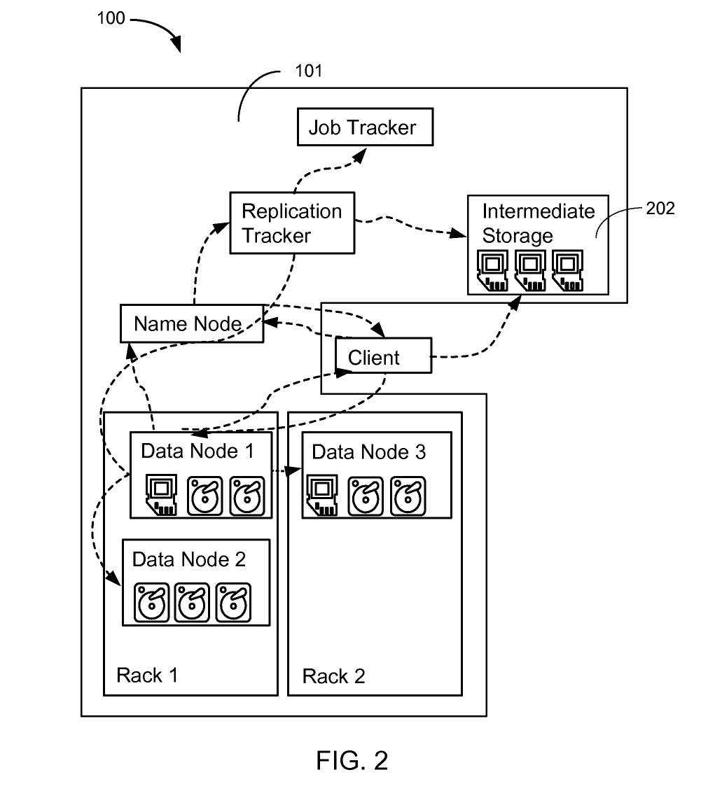

Referring now to FIG. 2, therein is shown the computing system 100 with a heterogeneous storage mechanism in a further embodiment of the present invention. FIG. 2 depicts another embodiment of the computing system 100 where heterogeneous storage media is used. The interactions between components of the computing system 100 can be illustrated in dotted arrow lines.

In addition to the embodiment of the present invention as discussed in FIG. 1, the computing system 100 can include the computing block 101 with an intermediate storage 202. The intermediate storage 202 stores the data content 102 of FIG. 1. For example, the intermediate storage 202 is used to enhance the fault tolerance of the computing system 100.

Fault tolerance can represent an ability of the computing system 100 to continue operating in an event of a failure of one or more component of the computing system 100. For example, if one instance of the target device 113 of FIG. 1 fails before the background replication 120 of FIG. 1 is completed, the computing system 100 can restore the data content 102 from the intermediate storage 202. The intermediate storage 202 can comprise the high performance device(s) 109, the low performance device(s) 111, or a combination thereof.

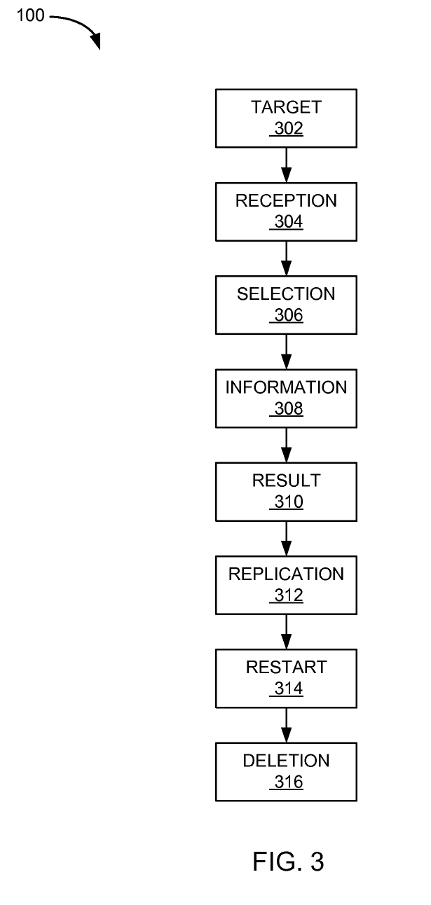

Referring now to FIG. 3, therein is shown a control flow of the computing system 100. The computing system 100 can include a target module 302. The target module 302 determines the target device 113 of FIG. 1. For example, the target module 302 can determine the target device 113 based on the storage media type 104 of FIG. 1, the storage performance of FIG. 1, or a combination thereof. For further example, the name node block 112 can execute the target module 302.

The target module 302 can determine the target device 113 in a number of ways. For example, the target module 302 can determine whether the target device 113 represents the data node 108 that includes the storage media type 104 of the high performance device 110 or the low performance device 111. For a specific example, the target module 302 can determine whether the storage media type 104 represents the SSD 105 or the HDD 107. For a different example, the target module 302 can determine the storage performance of the data node 108. The target module 302 can determine the storage performance based on the throughput, capacity, or a combination thereof of the storage unit 103 included in the data node 108 for selecting the target device 113.

For further example, the target module 302 can determine that a plurality of the data node 108 are available for writing the data content 102 of FIG. 1 for the client block 106 of FIG. 1. In a heterogeneous storage architecture, the target module 302 can determine the plurality of the data node 108 available to write the data content 102. More specifically as an example, the target module 302 can determine more than one instances of the data node 108 to store the data content 102. As an example, out of the three instances of the data node 108, the target module 302 can determine one instance of the data node 108 to include one instance representing the high performance device 110 and the other two instances representing the low performance device 111.

The computing system 100 can include a reception module 304, which can be coupled to the target module 302. The reception module 304 receives commands. For example, the reception module 304 can receive the write command 118 of FIG. 1 based on the storage media type 104, the storage performance, or a combination thereof. For further example, the target device 113 can execute the reception module 304.

The reception module 304 can receive the command in a number of ways. For example, the reception module 304 can receive the write command 118 for the target device 113 including the high performance device 110. As an example, the reception module 304 can receive the write command 118 to write to the data node 108 determined to include the storage unit 103 representing the storage media type 104 of the SSD 105.

For further example, the reception module 304 can receive the write command 118 to write to the high performance device 110 prior to replicating the data content 102 to the low performance device 111. For a specific example, the reception module 304 can receive the write command 118 as the first copy write command 116 as discussed above.

For another example, the reception module 304 can receive the write command 118 based on the executor type 136 of FIG. 1. The executor type 136 can represent the client block 106. The reception module 304 can receive the write command 118 to write the data content 102 commanded from the client block 106.

For further example, the reception module 304 can receive the write command 118 to write the data content 102 to the intermediate storage 202 of FIG. 2. More specifically as an example, the reception module 304 can receive the write command 118 to write the data content 102 to the intermediate storage 202 to enhance fault tolerance.

The computing system 100 can include a selection module 306, which can be coupled to the reception module 304. The selection module 306 selects the target device 113. For example, the selection module 306 can select the target device 113 based on the storage media type 104, the storage performance, the device location 122, or a combination thereof for executing the write command 118 for replicating the write of the data content 102 to the data node 108 with lower instance of the storage performance. The storage performance can include information related to current computing or processing activity by the target device 113, the data requirement of the data content 102 for storing at the target device 113, or a combination thereof. For further example, the name node block 112 can execute the selection module 306.

The selection module 306 can select the data node 108 in a number of ways. For example, the selection module 306 can select a plurality of the target device 113 different from the target device 113 where the first copy write command 116 was performed.

For a different example, the selection module 306 can select the data node 108 based on the storage media type 104 of the storage unit 103 different from the storage unit 103 with the storage media type 104 where the write command 118 is executed for the first copy write command 116. More specifically as an example, the selection module 306 can select the low performance device 111 if the write command 118 executed for the first copy write command 116 was to the high performance device 110.

For a different example, the selection module 306 can select the target device 113 based on the device location 122 of FIG. 1. More specifically as an example, the selection module 306 can select the target device 113 in the same instance of the device location 122 of the target device 113 where the first copy write command 116 was performed. For further example, if there were three instances of the target device 113 determined, the selection module 306 can select two instances of the target device 113 with the same instance of the device location 122 and can select one other instance of the target device 113 in a different instance of the device location 122.

For further example, the selection module 306 can select the target device 113 based on the storage performance of the target device 113 in relation to the processing attributes of the target device 113. More specifically as an example, the target device 113 can be occupied processing the data content 102. The selection module 306 can select the target device 113 based on the computing or processing activity by selecting the target device 113 having the storage performance to handle the additional load of the data content 102 required by the process consuming the data content 102. For another example, the selection module 306 can select the target device 113 meeting or exceeding the data requirement of the data content 102 to process the data content 102.

The computing system 100 can include an information module 308, which can be coupled to the selection module 306. The information module 308 communicates the transaction information 124 of FIG. 1. For example, the information module 308 can communicate the transaction information 124 to the replication tracker block 126 of FIG. 1. The name node block 112 can execute the information module 308.

More specifically as an example, the information module 308 can communicate the transaction information 124 including the target device 113 selected for executing the write command 118 for replicating the write of the data content 102. For further example, the information module 308 can communicate the transaction information 124 including the write command 118, the data content 102, or a combination thereof that was executed for the first copy write command 116.

The computing system 100 can include a result module 310, which can be coupled to the information module 308. The result module 310 communicates the transaction message 128 of FIG. 1. For example, the result module 310 can communicate the transaction message 128 based on the transaction status 130 of FIG. 1. For further example, the target device 113 can execute the result module 310.

More specifically as an example, the result module 310 can communicate the transaction message 128 including the transaction status 130 to the recipient type 138 of FIG. 1. For a specific example, the recipient type 138 can include the name node block 112 of FIG. 1, the client block 106, or a combination thereof. The transaction status 130 can represent “complete” or “error.” The result module 310 can communicate the transaction message 128 to a replication module 312.

The computing system 100 can include the replication module 312, which can be coupled to the result module 310. The replication module 312 replicates the command. For example, the replication module 312 can replicate the write command 118 by executing the write command 118 to the target device 113 different from the target device 113 where the first copy write command 116 was performed. For further example, the replication tracker block 126 can execute the replication module 312.

The replication module 312 can replicate the command in a number of ways. For example, the replication module 312 can replicate the write command 118 by executing the write command 118 to write the data content 102 in the background after the first copy write command 116. As discussed above, the first copy 115 of the same instance of the data content 102 can be written to the target device 113 including the high performance device 110 prior to the writing on the low performance device 111.

For a different example, the replication module 312 can perform the background replication 120 of FIG. 1. As discussed above, the replication module 312 can replicate the write command 118 by executing the write command 118 to write the data content 102 in the background to the low performance device 111. For another example, the replication module 312 can perform the background replication 210 differently. More specifically as an example, the replication module 312 can replicate the write command 118 by executing the write command 118 to different instances of the data node 108 compared to the data node 108 where the first copy write command 116 was performed.

For further example, the replication module 312 can replicate the write command 118 based on the transaction message 128. More specifically as an example, if the transaction status 130 included in the transaction message 128 from performing the first copy write command 116 to the target device 113 represents “complete,” the replication module 312 can replicate the write command 118 in the background as discussed above.

For a specific example, if the target count 114 is three, the data content is first written to one of the target device 113. The replication module 312 can replicate the write command 118 to the two remaining instances of the target device 113 in sequence, parallel, or a combination thereof.

For further example, the replication module 312 can execute the write command 118 based on the executor type 136. The executor type 136 can represent the replication tracker block 126. The reception module 304 can execute the write command 118 to write the data content 102 commanded from the replication tracker block 126.

It has been discovered that the computing system 100 performing the background replication 120 during, after, or a combination thereof with the first copy write command 116 can improve the performance per cost for writing the data content 102 to the target device 113. By performing the background replication 120 to a storage media type 104 different from the storage media type 104 utilized for the first copy write command 116, the computing system 100 can efficiently write the data content 102 in a heterogeneous architecture including various instances of the storage media type 104. As a result, the computing system 100 can improve the efficiency and performance of operating the computing system 100.

The computing system 100 can include a restart module 314, which can be coupled to the replication module 312. The restart module 314 communicates the restart request 132 of FIG. 1. For example, the restart module 314 can communicate the restart request 132 based on the transaction message 128. For further example, the replication tracker block 126 can execute the restart module 314.

More specifically as an example, if the transaction message 128 represented the transaction status 130 of “error” due to the loss of the data content 102 before the completion of the replication, the restart module 314 can communicate the restart request 132 to the replication module 312 to reissue the write command 118 to replicate the data content 102. More specifically as an example, the replication tracker block 126 can request the job tracker block 134 of FIG. 1 to reissue the task.

The computing system 100 can include a deletion module 316, which can be coupled to the restart module 314. The deletion module 316 deletes the data content 102. For example, the deletion module 316 can delete the data content 102 from the intermediate storage 202. For further example, the replication tracker block 126 can execute the deletion module 314 to delete the data content 102 from the intermediate storage 202.

More specifically as an example, the deletion module 316 can delete the data content 102 from the intermediate storage 202 if the transaction status 130 for replicating the data content 102 represents “complete.” The replication tracker block 126 can notify the intermediate storage 202 for deleting the data content 102 from the intermediate storage 202.

The modules described in this application can be implemented as instructions stored on a non-transitory computer readable medium to be executed by the computing block 101 of FIG. 1. The non-transitory computer medium can include the storage unit 103. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

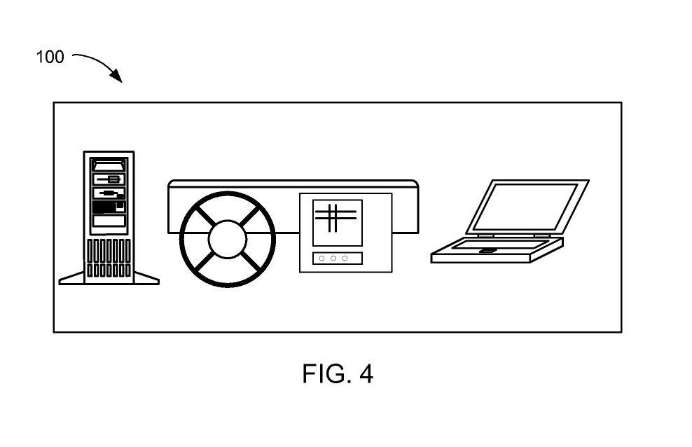

Referring now to FIG. 4, therein are application examples of the computing system 100 with an embodiment of the present invention. FIG. 4 depicts various embodiments, as examples, for the computing system 100, such as a computer server, a dash board of an automobile, a smartphone, a mobile device, and a notebook computer.

These application examples illustrate the importance of the various embodiments of the present invention to provide improved efficiency for storing the data content 102 of FIG. 1. The background replication 120 of FIG. 1 can replicate the data content 102 after the first copy write command 116 of FIG. 1 is executed. The background replication 120 improves efficiency by marking the write command 118 as complete after the first copy write command 116 is complete but while the background replication 120 is processing in the background.

The computing system 100, such as the computer server, the dash board, and the notebook computer, can include a one or more of a subsystem (not shown), such as a printed circuit board having various embodiments of the present invention or an electronic assembly having various embodiments of the present invention. The computing system 100 can also be implemented as an adapter card.

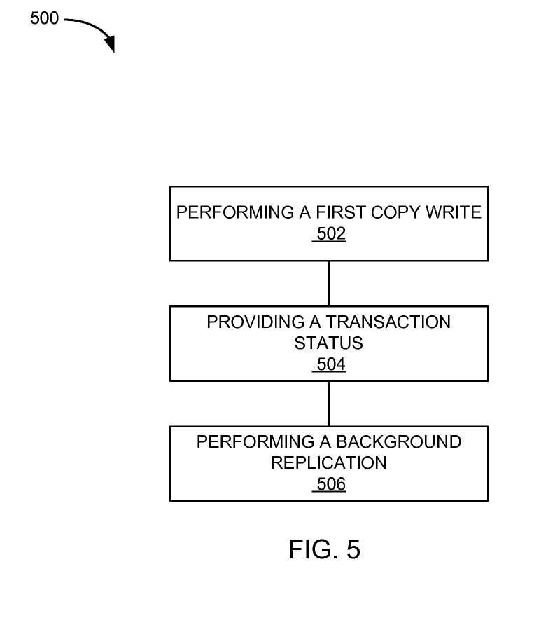

Referring now to FIG. 5, therein is shown a flow chart of a method 500 of operation of a computing system 100 in an embodiment of the present invention. The method 500 includes: performing a first copy write command for writing to a high performance device in a block 502, providing a transaction status as completed for the first copy write command in a block 504, and performing a background replication with a replication tracker block for replicating a data content from the first copy write command to a target device after the transaction status is provided as completed in a block 506.

The block 506 can further include performing the background replication for replicating the data content to the target device representing a data node different from the data node where the first copy write command is completed and performing the background replication for replicating the data content to the target device representing a low performance device. The method 500 can further include executing a write command for the background replication for writing the data content to a storage unit different from the storage unit where the first copy write command is completed and communicating a restart request based on a transaction status for failing to complete the first copy write command, the background replication, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a name node block configured to:
determine a data node including a high performance device,
select a target device;
wherein the data node, coupled to the name node block, is configured to:
perform a first copy write command to the high performance device,
provide a transaction status as completed for the first copy write command; and
a replication tracker block, coupled to the data node, configured to perform a background replication to replicate a data content from the first copy write command to the target device after the transaction status is provided as completed.

2. The system as claimed in claim 1 wherein the replication tracker block is configured to perform the background replication to replicate the data content to the target device representing another instance of the data node.

3. The system as claimed in claim 1 wherein the replication tracker block is configured to perform the background replication to replicate the data content to the target device representing a low performance device.

4. The system as claimed in claim 1 wherein the replication tracker block is configured to execute a write command for the background replication for writing the data content to the storage unit different from the storage unit where the first copy write command is completed.

5. The system as claimed in claim 1 wherein the replication tracker block is configured to communicate a restart request based on a transaction status for failing to complete the first copy write command, the background replication, or a combination thereof.

6. The system as claimed in claim 1 further comprising the data node configured to receive the data content from an intermediate storage for performing the first copy write command to the data node.

7. The system as claimed in claim further comprising an intermediate storage configure to delete the data content based on a transaction status for completing the first copy write command, the background replication, or a combination thereof.

8. The system as claimed in claim 1 further comprising the data node configured to receive a write command for performing the first copy write command to a solid state drive over a hard disk drive.

9. The system as claimed in claim 1 wherein the replication tracker block is configured to perform the background replication to a hard disk drive after the first copy write command is performed on a solid state drive.

10. The system as claimed in claim 1 wherein the replication tracker block is configured to communicate a restart request for reissuing a write command to replicate the data content.

11. A method of operation of a computing system comprising:
performing a first copy write command for writing to a high performance device;
providing a transaction status as completed for the first copy write command; and
performing a background replication with a replication tracker block for replicating a data content from the first copy write command to a target device after the transaction status is provided as completed.

12. The method as claimed in claim 11 wherein performing the background replication includes performing the background replication for replicating the data content to the target device representing a data node different from the data node where the first copy write command is completed.

13. The method as claimed in claim 11 wherein performing the background replication includes performing the background replication for replicating the data content to the target device representing a low performance device.

14. The method as claimed in claim 11 further comprising executing a write command for the background replication for writing the data content to a storage unit different from the storage unit where the first copy write command is completed.

15. The method as claimed in claim 11 further comprising communicating a restart request based on a transaction status for failing to complete the first copy write command, the background replication, or a combination thereof.

16. A non-transitory computer readable medium including instructions for execution by a computer block comprising:
performing a first copy write command for writing to a high performance device;
providing a transaction status as completed for the first copy write command; and
performing a background replication for replicating a data content from the first copy write command to a target device after the transaction status is provided as completed.

17. The non-transitory computer readable medium as claimed in claim 16 wherein performing the background replication includes performing the background replication for replicating the data content to the target device representing a data node different from the data node where the first copy write command is completed.

18. The non-transitory computer readable medium as claimed in claim 16 wherein performing the background replication includes performing the background replication for replicating the data content to the target device representing a low performance device.

19. The non-transitory computer readable medium as claimed in claim 16 further comprising executing a write command for the background replication for writing the data content to a storage unit different from the storage unit where the first copy write command is completed.

20. The non-transitory computer readable medium as claimed in claim 16 further comprising communicating a restart request based on a transaction status for failing to complete the first copy write command, the background replication, or a combination thereof.
